(19) United States
(12) Patent Application Publication
(10) Pub. No.: US 2026/0213640 A1
(43) Pub. Date: Jul. 23, 2026

(54) POWER CONVERTER AND CONTROLLING METHOD THEREOF AND CONTROLLER

(71) Applicant: Chicony Power Technology Co., Ltd., New Taipei City (TW)

(72) Inventors: Min-Han LEE, New Taipei City (TW); Meng-Yuan TSAI, New Taipei City (TW)

(21) Appl. No.: 19/200,693

(22) Filed: May 7, 2025

(30) Foreign Application Priority Data
Jan. 23, 2025 (TW) 114103236

(51) Int. Cl. H02M 1/00; H02M 1/42; H02M 3/335

(52) U.S. Cl. CPC H02M 1/0058; H02M 1/42; H02M 3/33569

(57) ABSTRACT

A power converter includes a transformer, a resonant circuit, a switch circuit, and an auxiliary circuit. The transformer includes a primary side winding disposed on a primary side of the transformer, a magnetic inductor coupled to the primary side winding in parallel, and a secondary side winding disposed on a secondary side of the transformer and coupled to the primary side winding. The resonant circuit is coupled to the primary side winding. The switch circuit includes a first switch and a second switch coupled to the first switch in series. The resonant circuit is coupled between the first switch and the second switch. The auxiliary circuit disposed on the primary side includes an auxiliary winding, an auxiliary switch coupled to the auxiliary winding, and an auxiliary capacitor coupled to the auxiliary switch in series.

### CROSS-REFERENCE TO RELATED APPLICATION

This application claims priority to Taiwan Application Serial Number 114103236, filed Jan. 23, 2025, which is herein incorporated by reference in its entirety.

### BACKGROUND

### Field of Invention

The present disclosure relates to a power converter, and in particular to a power converter capable of achieving zero-voltage switching in a discontinuous resonant mode and a controller for controlling the power converter.

### Description of Related Art

As consumer electronic products increasingly demand higher power and smaller size for adapters, switch-mode power converters have become the mainstream in consumer electronics applications, replacing linear regulators due to their high efficiency and compact form factor.

Conventional switch-mode power converters typically use metal oxide semiconductor field effect transistors (MOSFETs) as switching components in a pulse width modulation (PWM) control. The MOSFETs are preferred due to their fast switching speed and low losses. However, if an output parasitic capacitance of the MOSFET is not fully discharged when a switch is switched on, a voltage difference crosses a drain terminal and a source terminal of the MOSFET. This voltage difference, combined with the current flowing through a source of MOSFET, results in power loss, known as MOSFET switching loss.

To reduce switching losses, conventional asymmetric half-bridge flyback converters typically continue to turn on a low-side switch after the magnetic inductor discharges completely to zero amperes (A), which allows inverse charging of the magnetic inductor and results inverse current. This inverse current then discharges the parasitic capacitor of a high-side switch, achieving zero voltage switching (ZVS). This operational mode is referred to as a continuous resonant mode.

While the continuous resonant mode works effectively under high voltage and full load conditions, it encounters challenges when a load decreases or the output voltage drops. In such cases, a peak current of the magnetic inductor also decreases, leading to an excessively high operating frequency and limiting overall efficiency of the power converter due to the circulating energy in a resonant tank. To address this, asymmetric half-bridge flyback converters commonly operate in a discontinuous resonant mode under the load decreasing or low output voltage conditions. However, in the discontinuous resonant mode, the switch is switched off as soon as the magnetic inductor current discharges to zero, indicating that there is no inverse magnetic current available to achieve zero voltage switching. As a result, additional switching losses occur. Therefore, developing a power conversion solution to address these issues is a critical topic in this field.

### SUMMARY

A power converter is provided and includes a transformer, a resonant circuit, a switch circuit, and an auxiliary circuit. The transformer includes a primary side winding disposed on a primary side of the transformer, a magnetic inductor coupled to the primary side winding in parallel, and a secondary side winding disposed on a secondary side of the transformer and coupled to the primary side winding. The resonant circuit is coupled to the primary side winding. The switch circuit includes a first switch and a second switch coupled to the first switch in series, in which the resonant circuit is coupled between the first switch and the second switch. The auxiliary circuit disposed on the primary side includes an auxiliary winding, an auxiliary switch coupled to the auxiliary winding, and an auxiliary capacitor coupled to the auxiliary switch in series, in which the auxiliary switch is switched off and the magnetic inductor is discharged to charge the auxiliary capacitor, in which the auxiliary switch is switched on to make the auxiliary capacitor charge the magnetic inductor to generate an exciting current, and the exciting current switches on a parasitic diode of the first switch.

A method of controlling the power converter is provided, in which the power converter includes the switch circuit having the first switch and the second switch, the transformer having the primary side winding, the magnetic inductor, and the secondary side winding, the resonant circuit coupled between the primary side winding and the switch circuit, and the auxiliary circuit having the auxiliary winding, the auxiliary switch, and the auxiliary capacitor, in which the auxiliary circuit and the primary side winding is disposed on a same side of the transformer. The method includes: switching on the second switch and charging the auxiliary capacitor up to a first interval by discharging the magnetic inductor; switching off the second switch and switching on the auxiliary switch to make the auxiliary capacitor charge the magnetic inductor to generate the exciting current during a second interval, in which the second interval is after the first interval; and switching off the auxiliary switch and switching on the parasitic diode of the first switch by the exciting current flowing through the first switch during a third interval, in which the third interval is after the second interval.

A controller is provided and configured to control a power converter, in which the power converter includes the switch circuit having the first switch and the second switch, the transformer having the primary side winding, the magnetic inductor, and the secondary side winding, the resonant circuit coupled between the primary side winding and the switch circuit, and the auxiliary circuit having the auxiliary winding, the auxiliary switch, and the auxiliary capacitor, in which the auxiliary circuit and the primary side winding is disposed on the same side of the transformer, in which the controller is configured to: switch on the second switch and charge the auxiliary capacitor up to the first interval by discharging the magnetic inductor; switch off the second switch and switch on the auxiliary switch to make the auxiliary capacitor charge the magnetic inductor to generate the exciting current during the second interval, in which the second interval is after the first interval; and switch off the auxiliary switch and switch on the first switch after switching on the parasitic diode of the first switch by the exciting current flowing through the first switch during the third interval, in which the third interval is after the second interval.

### BRIEF DESCRIPTION OF THE DRAWINGS

The invention can be more fully understood by reading the following detailed description of the embodiment, with reference made to the accompanying drawings as follows:

FIG. 1 illustrates a schematic diagram of a power converter and a controller, in accordance with one embodiment of the present disclosure.

FIG. 2 illustrates a flow chart of a method of controlling the power converter of FIG. 1, in accordance with one embodiment of the present disclosure.

FIG. 3 illustrates an oscillogram of the plurality of signals of the power converter, in accordance with one embodiment of the present disclosure.

FIG. 4 to FIG. 10 illustrate diagrams of operation of the power converter of FIG. 1 during various intervals, in accordance with one embodiment of the present disclosure.

FIG. 11 illustrates a schematic diagram of a power converter, in accordance with another embodiment of the present disclosure.

### DETAILED DESCRIPTION

The following provides a detailed description of exemplary embodiments in conjunction with the accompanying drawings. However, the provided embodiments are not intended to limit the scope of the present disclosure. The described structural operations are not intended to constrain their execution sequence. Any structure formed by the recombination of components, resulting in a device with equivalent effects, is within the scope of the present disclosure. Additionally, the drawings are for illustrative purposes only and are not drawn to scale. For ease of understanding, identical or similar components in the following description are indicated by the same reference symbols.

As used herein, the terms “coupled to” or “connected to” may refer to direct physical or electrical contact between two or more components, indirect physical or electrical contact between two or more components, or the interaction or operation of two or more components.

In this document, the term “circuit” broadly refers to an object composed of one or more transistors and/or one or more active or passive components connected in a specific manner to process signals.

The terms used throughout the specification and claims, unless specifically stated otherwise, generally carry their ordinary meanings as understood in the relevant field, as disclosed herein, and within the context of the present disclosure. In addition, the terms “includes,” “including,” “having,” and similar expressions used herein are open-ended terms, meaning “includes but is not limited to.” Furthermore, the term “and/or” used herein includes any one or more of the listed items as well as any and all combinations thereof.

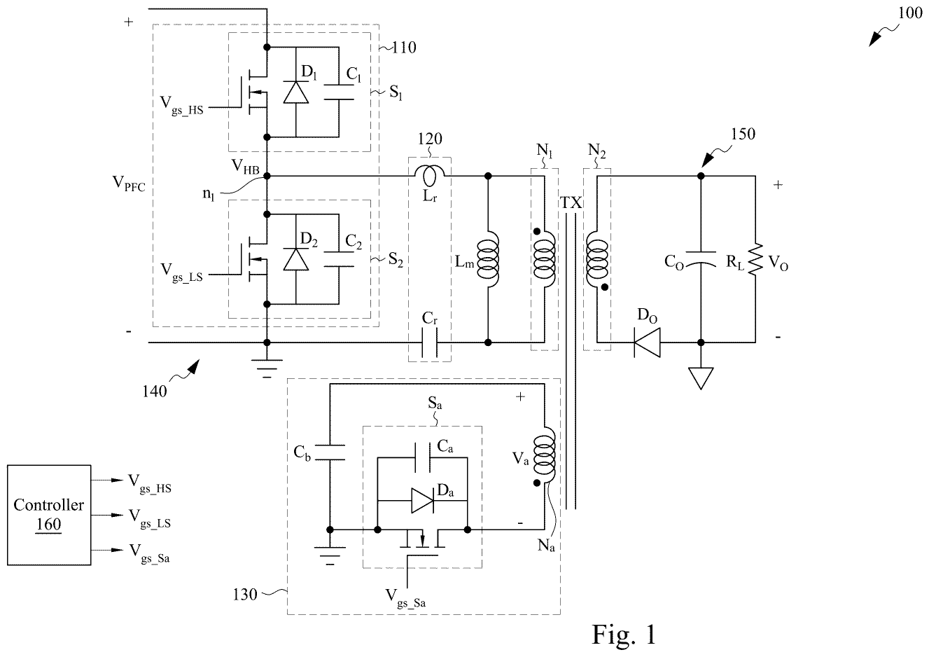

Please refer to FIG. 1, FIG. 1 illustrates a schematic diagram of a power converter 100 and a controller 160, in accordance with one embodiment of the present disclosure. As shown in FIG. 1, the power converter 100 includes a switch circuit 110, a resonant circuit 120, an auxiliary circuit 130, a transformer TX, a diode D_{O} and a capacitor C_{O}. In some embodiments, the power converter 100 is coupled to a load R_{L}, and configured to generate an output voltage V_{O} to the load R_{L} based on an input voltage V_{PFC} received by the switch circuit 110. In some embodiments, the diode D_{O} can be replaced with metal oxide semiconductor field effect transistor (MOSFET). In some embodiments, the controller 160 is configured to generate signals to control the operation of the power converter 100, and can be a microprocessor or any suitable integrated circuits.

In some embodiments, the transformer TX includes a primary side winding N₁, a magnetic inductor Lₘ and a secondary side winding N₂. The primary side winding N₁ is disposed on a primary side 140 of the transformer TX, and the secondary side winding N₂ is disposed on a secondary side 150 of the transformer TX. As shown in FIG. 1, the switch circuit 110, the resonant circuit 120 and the auxiliary circuit 130 are on the primary side 140. The diode D_{O}, the capacitor C_{O}, the load R_{L} are located on the secondary side 150.

In some embodiments, the switch circuit 110 includes a switch S₁ and a switch S₂. The switch S₁ includes a parasitic capacitor C₁ and a parasitic diode D₁, and is switched on or off in response to a signal V_{gs_HS} received at a gate terminal thereof. The switch S₂ includes a parasitic capacitor C₂ and a parasitic diode D₂, and the switch S₂ is switched on or off in response to a signal V_{gs_LS} received at a gate terminal thereof. The switch S₁ is coupled between a positive input terminal of the input voltage V_{PFC} and a node n₁ between the switch S₁ and the switch S₂. The switch S₂ is coupled between the node n₁ and the ground terminal.

In some embodiments, the resonant circuit 120 includes an inductor Lᵣ and a capacitor Cᵣ. The inductor Lᵣ is coupled between a dotted terminal of the primary side winding N₁ and the node n₁ and coupled to one terminal of the magnetic inductor Lₘ at the dotted terminal of the primary side winding N₁. The capacitor Cᵣ is coupled between a non-dotted terminal of the primary side winding N₁ and the ground terminal and coupled to the other terminal of the magnetic inductor Lₘ at the non-dotted terminal of the primary side winding N₁. In some embodiments, the inductor Lᵣ is a leakage inductor or an independent inductor of the transformer TX.

In some embodiments, the auxiliary circuit 130 includes an auxiliary switch Sₐ and an auxiliary capacitor C_{b} and an auxiliary winding Nₐ. The auxiliary switch Sₐ includes an auxiliary parasitic capacitor Cₐ and a parasitic diode Dₐ, and is switched on or off in response to a signal V_{gs_Sa} received at a gate terminal thereof. The auxiliary switch Sₐ is coupled between a dotted terminal of the auxiliary winding Nₐ and the ground terminal. The auxiliary capacitor C_{b} is coupled between a non-dotted terminal of the auxiliary winding Nₐ and the ground terminal. In some embodiments, a capacitance value of the parasitic capacitor C₁ is less than a capacitance value of the auxiliary capacitor C_{b} (also referred to as an “energy storage capacitance value”). In some embodiments, a capacitance value of the parasitic capacitor C₂ is less than the capacitance value of the auxiliary capacitor C_{b}. In some embodiments, a capacitance value of the auxiliary parasitic capacitor Cₐ is less than the capacitance value of the parasitic capacitor C₁. In some embodiments, the capacitance value of the auxiliary parasitic capacitor Cₐ is less than the capacitance value of the parasitic capacitor C₂.

In coupling relationship in the secondary side 150, a positive terminal of the diode D_{O} and one terminal of the capacitor C_{O} are coupled to the ground terminal, and a negative terminal of the diode D_{O} is coupled to a dotted terminal of the secondary side winding N₂. The other terminal of the capacitor C_{O} is coupled to a non-dotted terminal of the secondary side winding N₂.

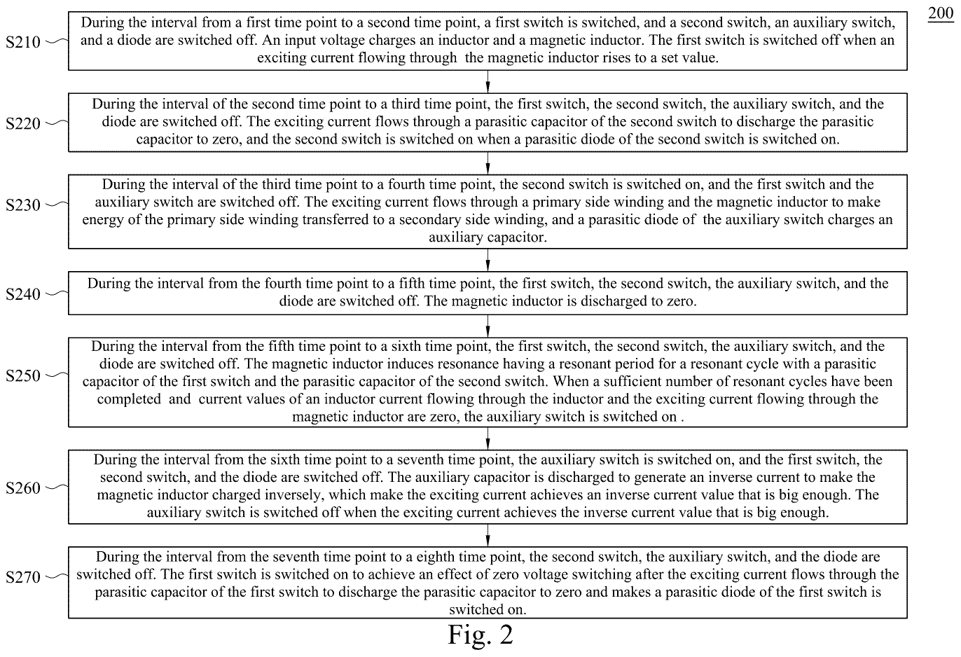

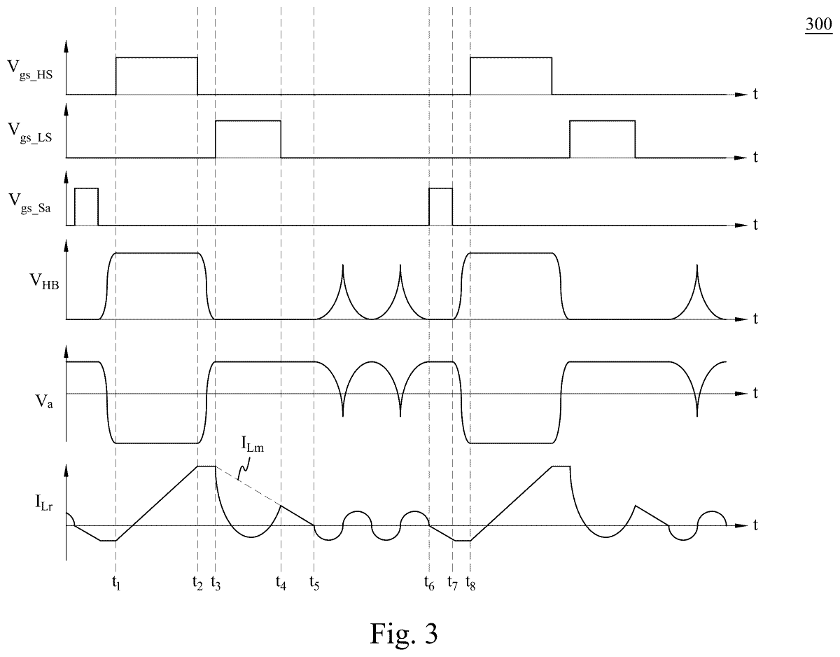

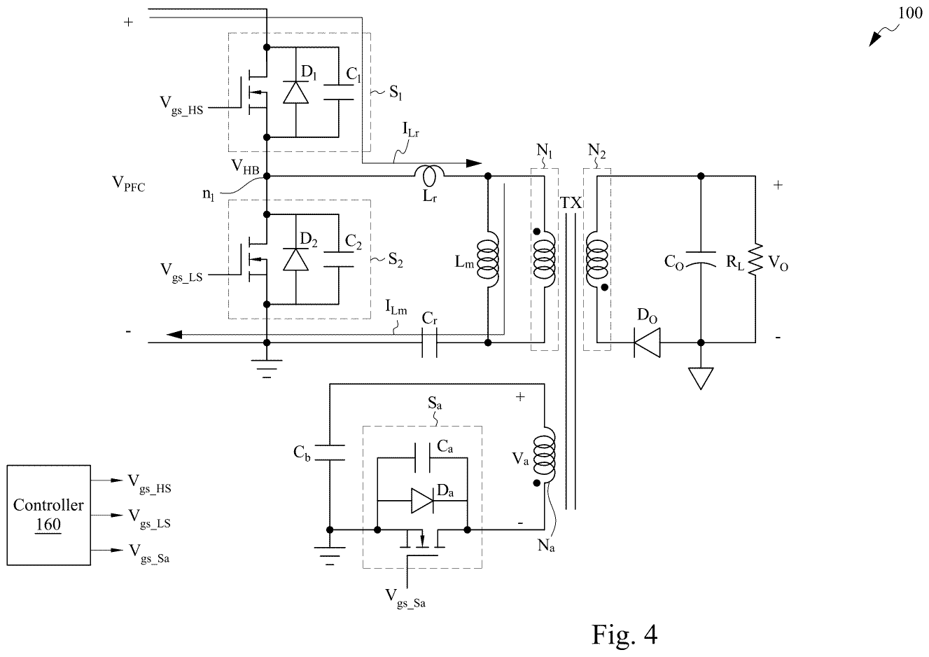

Please refer to FIG. 2, FIG. 3 and FIG. 4 to FIG. 10 together. FIG. 2 illustrates a flow chart of a method 200 of controlling the power converter 100 of FIG. 1, in accordance with one embodiment of the present disclosure. FIG. 3 illustrates an oscillogram 300 of the plurality of signals of the power converter 100, in accordance with one embodiment of the present disclosure. FIG. 4 to FIG. 10 illustrate diagrams of operation of the power converter 100 of FIG. 1 during various intervals, in accordance with one embodiment of the present disclosure. In some embodiments, the controller 160 performs the method 200 of controlling the power converter 100 to control the operation of the power converter 100.

According to operation S210, during the interval from a time points t₁ to t₂, as shown in FIG. 3 and FIG. 4, the switch S₁ is switched on in response to the signal V_{gs_HS} having high voltage level, and the switch S₂ and the auxiliary switch Sₐ are switched off in response to the signals V_{gs_LS} and V_{gs_Sa} with low voltage level respectively. The node n₁ has a voltage V_{HB}, and the voltage V_{HB} is pulled up in response to the input voltage V_{PFC} to charge the inductor Lᵣ and the magnetic inductor Lₘ, which makes the current I_{Lr} flowing through the inductor Lᵣ and the exciting current I_{Lm} flowing through the magnetic inductor Lₘ rise. The magnetic inductor Lₘ discharges the parasitic capacitor C₁ and charges the capacitor Cᵣ by the exciting current I_{Lm}. In some embodiments, when the exciting current I_{Lm} rises to a set value, the signal V_{gs_HS} turns to the low voltage level to switch off the switch S₁.

In addition, in the embodiment of FIG. 4, the diode D_{O} is switched off in response to its positive terminal grounded and its negative terminal having the low voltage level. Specifically, the dotted terminal of the primary side winding N₁ and the dotted terminal of the secondary side winding N₂ are the high voltage level. Thus, the negative terminal of the diode D_{O} coupled to the dotted terminal of the secondary side winding N₂ is the high voltage level, and the positive terminal of the diode D_{O} is grounded to make the diode D_{O} switched off.

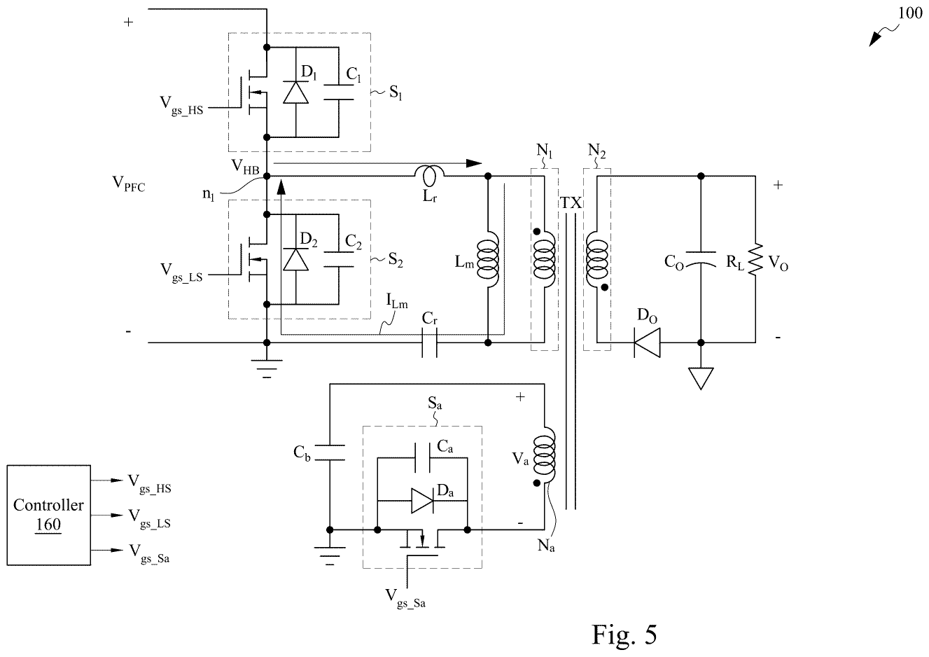

According to the operation S220, during the interval of the time points t₂ to t₃, as shown in FIG. 5, the switch S₁ is switched off in response to the signal V_{gs_HS} with the low voltage level, and the switch S₂, the auxiliary switch Sₐ and the diode D_{O} are kept switched off. The exciting current I_{Lm} discharges the parasitic capacitor C₂. When the parasitic capacitor C₂ is discharged completely, the exciting current I_{Lm} flows through the switched-on parasitic diode, making the switching loss of the switch S₂ approximate zero. Next, the signal V_{gs_LS} turns to have the high voltage level to switch on the switch S₂.

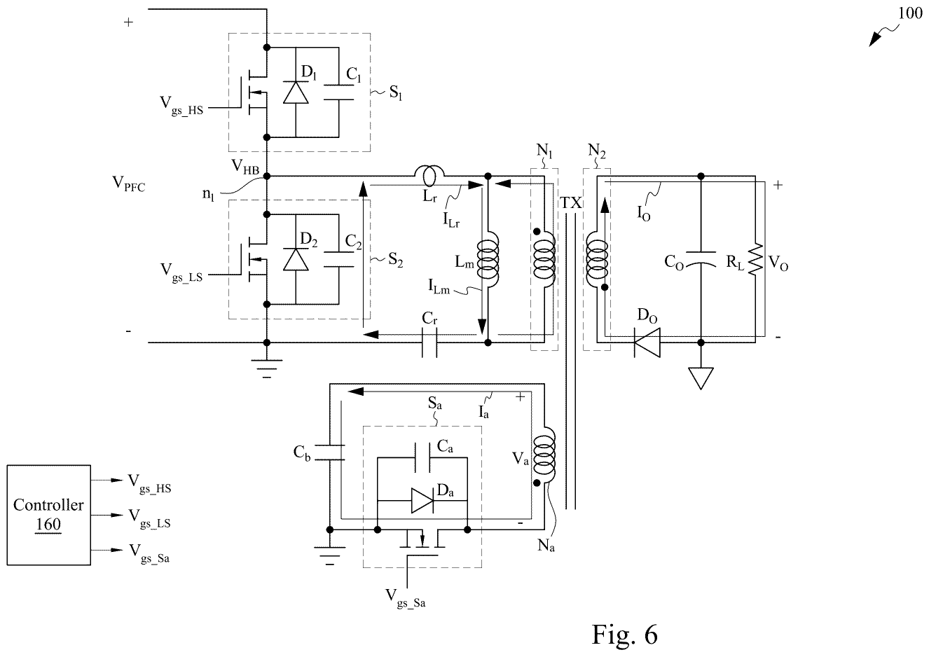

According to the operation S230, during the interval of the time points t₃ to t₄, as shown in FIG. 6, the switch S₂ is switched on in response to the signal V_{gs_LS} with the high voltage level, and the switch S₁ and the auxiliary switch Sₐ are kept switched off. The capacitor Cᵣ discharges to generate the current flowing through the primary side winding N₁, which makes energy of the primary side winding N₁ transferred to the secondary side winding N₂. The diode D_{O} is switched on and the secondary side winding N₂ generates a current Iₒ in response to the energy of the primary side winding N₁ being transferred to the secondary side winding N₂. In addition, the energy of the primary side winding N₁ is also transferred to the auxiliary winding Nₐ to generate the current Iₐ. The current Iₐ flows through the parasitic diode Dₐ and charges the auxiliary capacitor C_{b}.

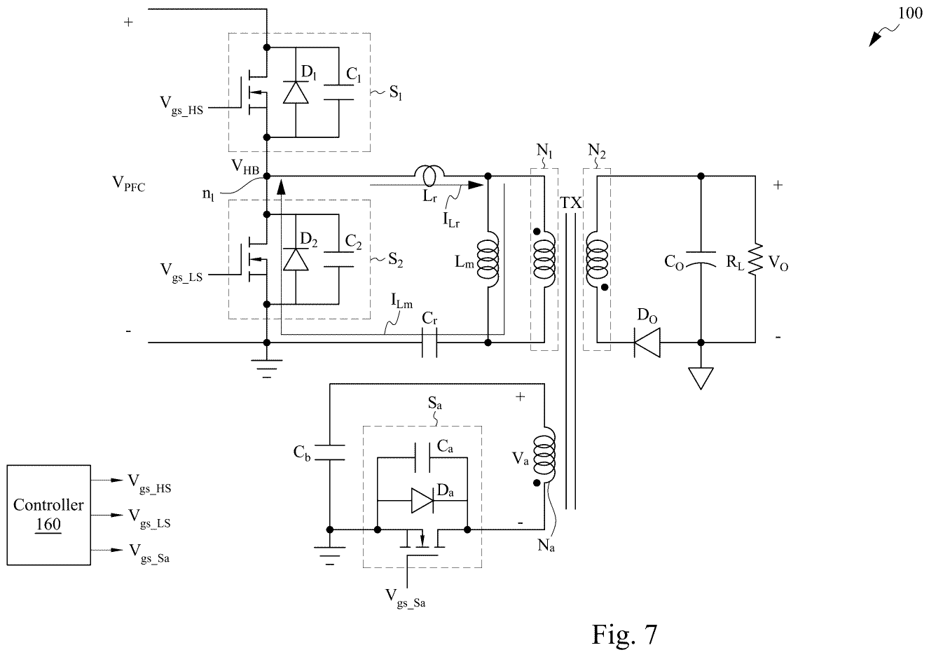

According to the operation S240, during the interval from the time points t₄ to t₅ (also referred to as a “discharging energy interval”), as shown in FIG. 7, the switch S₂ is switched off in response of the signal V_{gs_LS} having the low voltage level, and the switch S₁ and the auxiliary switch Sₐ are kept switched off. The current I_{Lr} flowing through the magnetic inductor Lᵣ and the exciting current I_{Lm} flowing the inductor Lₘ keep decreasing until a current value is zero (in other words, the magnetic inductor Lₘ is discharged to zero). During the discharging energy interval, no energy of the primary side winding N₁ is transferred to the auxiliary winding Nₐ, so the diode D_{O} is off.

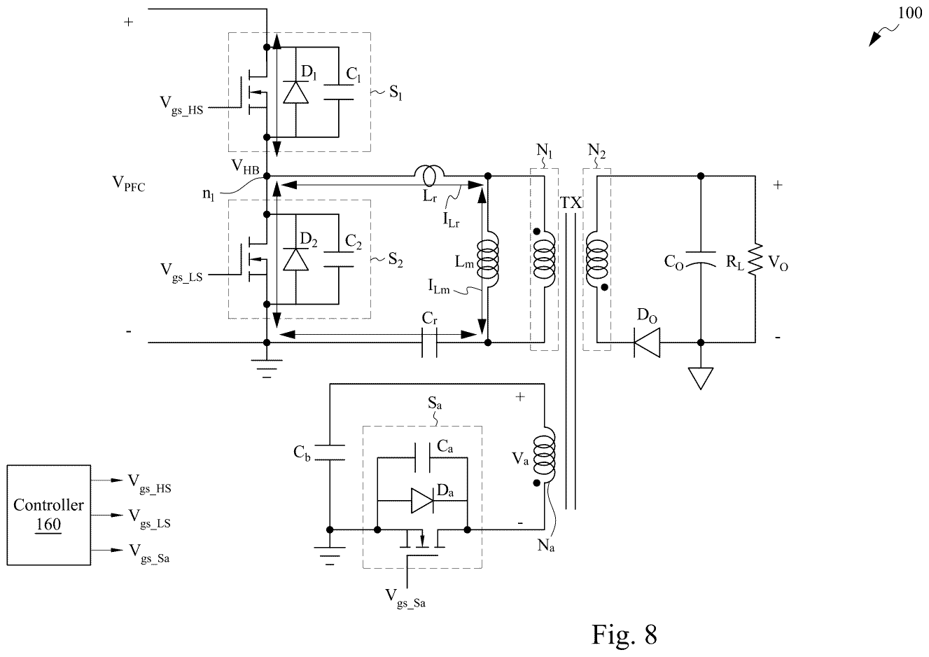

According to the operation S250, during the interval from the time points t₅ to t₆ (also referred to as a “resonant interval”), as shown in FIG. 8, the switch S₁, the switch S₂, the auxiliary switch Sₐ, and the diode D_{O} are kept switched off. The magnetic inductor Lₘ, the parasitic capacitor C₁ and the parasitic capacitor C₂ induce resonance having a resonant period for a resonant cycle. When a sufficient number of resonant cycles have been completed and the current values of the current Lᵣ flowing through the inductor Lᵣ and the exciting current I_{Lm} flowing through the magnetic inductor Lₘ are zero, the signal V_{gs_Sa} turns to have the high voltage level to switch on the auxiliary switch Sₐ. In some embodiments, the resonant period and the output voltage V_{O} are a positive correlation.

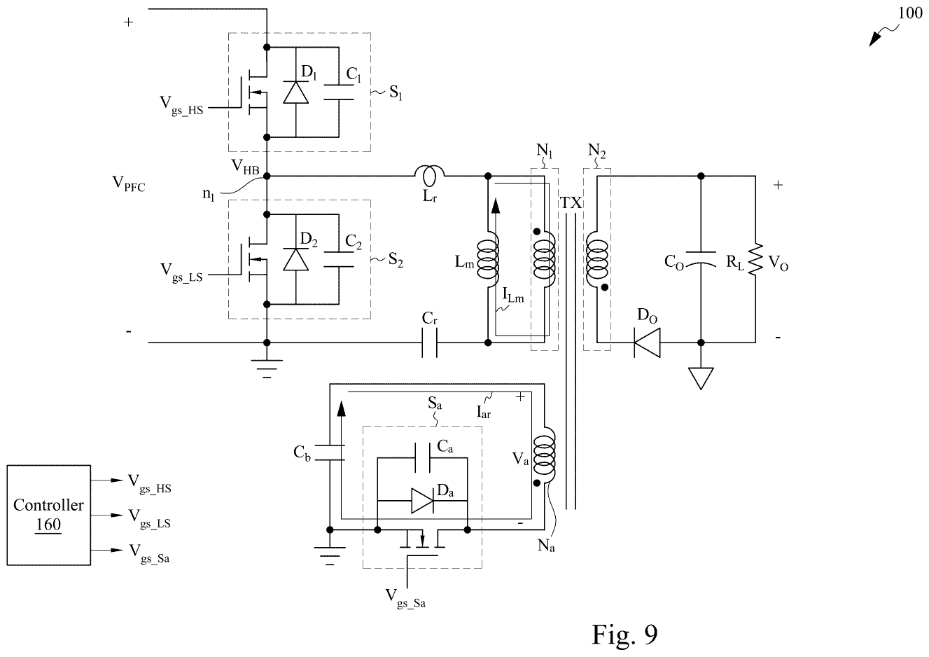

According to the operation S260, during the interval from the time points t₆ to t₇, as shown in FIG. 9, the auxiliary switch Sₐ is switched on in response to the signal V_{gs_Sa} with the high voltage level, and the switch S₁, the switch S₂ and the diode D_{O} are kept switched off. The auxiliary capacitor C_{b} is discharged to generate an inverse current Iₐᵣ to make the magnetic inductor Lₘ charged inversely, which makes the exciting current I_{Lm} achieve an inverse current value I_{MAGneg}. In some embodiments, the inverse current value I_{MAGneg} corresponds to the current value which is sufficient for discharging the parasitic capacitor C₁ completely and charging the parasitic capacitor C₂ completely. The inverse current value I_{MAGneg} is based on an equation (1)

$${I}_{MAGneg} = \sqrt{\frac{( {Coss}_{S 1} + C o s {s}_{S 2} ) \cdot {V}_{PFC}^{2}}{{L}_{m}}} \qquad ( 1 )$$

Cossₛ₁ represents the capacitance value of the parasitic capacitor C₁, Cossₛ₂ represents the capacitance value of the parasitic capacitor C₂, V_{PFC} represents a voltage value of the input voltage V_{PFC}, and Lₘ represents the inductor value of the magnetic inductor Lₘ. In some embodiments, when the exciting current I_{Lm} reaches the inverse current value I_{MAGneg}, the signal V_{gs_Sa} turns to have the low voltage level to switch off the auxiliary switch Sₐ.

As mentioned above, because operation of the auxiliary switch Sₐ is for charging the magnetic inductor Lₘ, in some embodiments, a size of a transistor of the auxiliary switch Sₐ is less than a size of a transistor of the switch S₁. In other words, a capacitance value of the auxiliary parasitic capacitor Cₐ is less than the capacitance value of parasitic capacitor C₁, which can also decrease a drive loss P_{gate} of the auxiliary switch Sₐ. The drive loss P_{gate} of the auxiliary switch Sₐ is based on an equation (2)

$${P}_{gate} = 0.5 \cdot Ciss \cdot {V}_{gate}^{2} \cdot {f}_{sw} \qquad ( 2 )$$

Ciss represents the capacitance value of the auxiliary parasitic capacitor Cₐ, V_{gate} represents a voltage value of a gate of the auxiliary switch Sₐ, and f_{sw} represents an operating frequency of the auxiliary switch Sₐ.

In some embodiments, the size of the transistor of the auxiliary switch Sₐ is less than a size of a transistor of the switch S₂.

In some embodiments, a voltage stress of the auxiliary switch Sₐ and a turn ratio of the primary side winding N₁ and the auxiliary winding Nₐ have a proportional relationship. For example, a voltage stress magnitude corresponding to the turns ratio value being 200% (i.e., a number of turns of the primary side winding N₁ is 20 and a number of the auxiliary winding Nₐ is 10) is half that corresponding to the turns ratio value being 100% (i.e., the number of the turns of the primary side winding N₁ is 10 and the number of the turns of the auxiliary winding Nₐ is 10).

In some embodiments, a switching loss P_{sw} of the auxiliary switch Sₐ is based on an equation (3)

$${P}_{s w} = 0.5 \cdot {I}_{d} \cdot {V}_{ds} \cdot ( {t}_{o n} + {t}_{off} ) \cdot {f}_{s w} \qquad ( 3 )$$

I_{d} corresponds to a current value of a drain of the auxiliary switch Sₐ, V_{ds} corresponds to a voltage value between the drain and a source of the auxiliary switch Sₐ, tₒₙ and t_{of} correspond to switching on time and switching off time of the auxiliary switch Sₐ respectively, and f_{sw} corresponds to the operating period.

In some embodiments, the interval from the time points t₆ to t₇ is shorter than the interval from the time points t₃ to t₄.

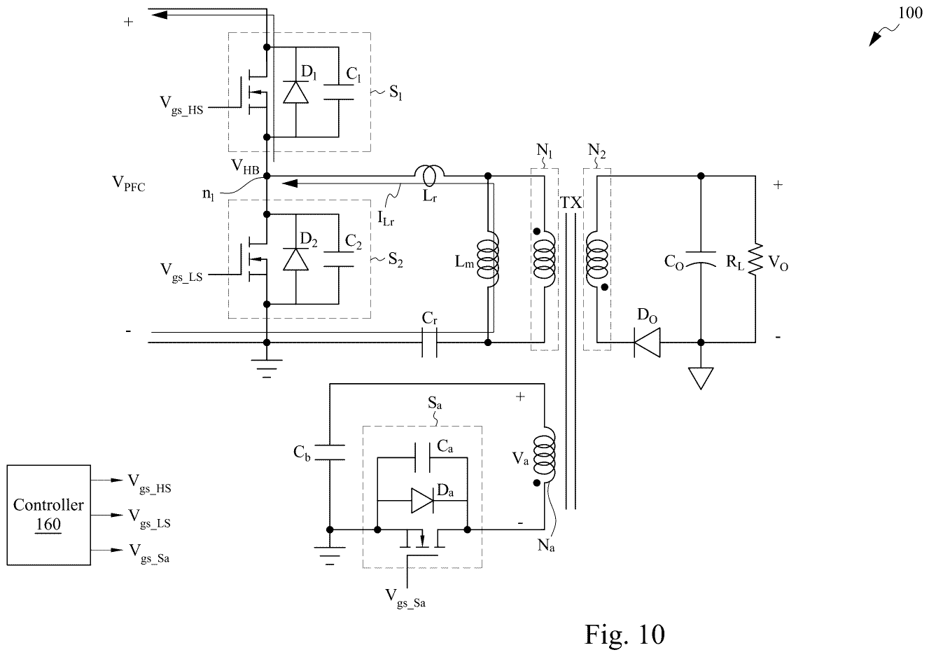

According to the operation S270, during the interval from the time points t₇ to t₈, as shown in FIG. 10, the auxiliary switch Sₐ is switched off in response to the signal V_{gs_Sa} having the low voltage level, the switch S₂ and the diode D_{O} are kept switched off. The exciting current I_{Lm} as the current Lᵣ discharges the parasitic capacitor C₁. When the parasitic capacitor C₁ is discharged completely, the current I_{Lm} flows through the switched-on parasitic diode D₁ to make the switch S₁ switched on and a switching loss almost zero, which achieves an effect of zero voltage switching (ZVS). Next, the signal V_{gs_HS} turns to have the high voltage level to switch on the switch S₁.

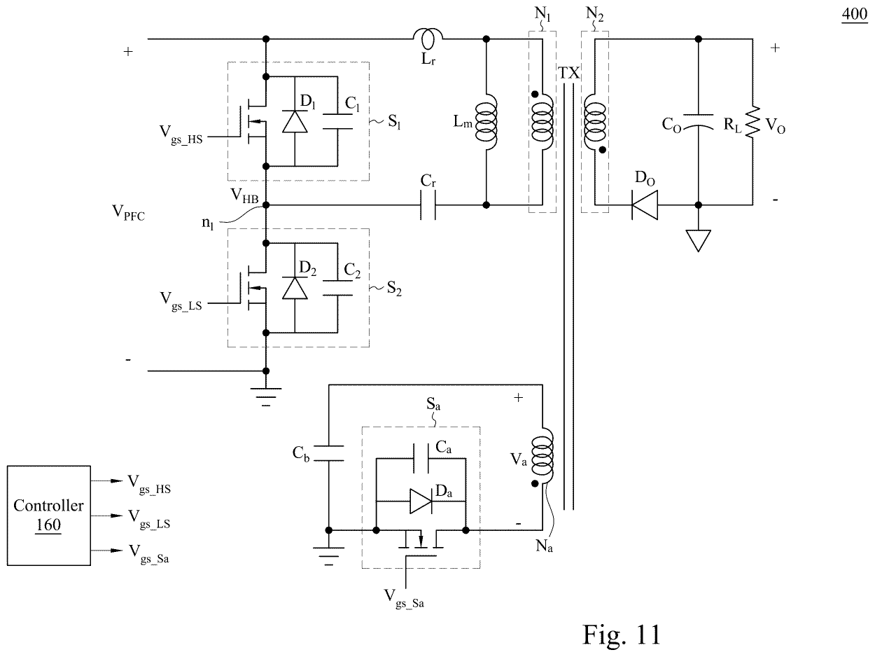

Please refer to FIG. 11, FIG. 11 illustrates a schematic diagram of a power converter 400. Compared to the power converter 100 of FIG. 1, the inductor Lᵣ is coupled between the dotted terminal of the primary side winding N₁ and a positive terminal of the input voltage V_{PFC}. The capacitor Cᵣ is coupled between non-dotted terminal of the primary side winding N₁ and the node n₁.

In summary, the power converter and controlling method thereof of the present disclosure make the power converter achieve zero voltage switching in a discontinuous resonance mode, which decreases the switching loss of the switch of the power converter.

Although the present disclosure has been described above with reference to the embodiments, it is not intended to limit the scope of the present disclosure. Various modifications and refinements may be made by those skilled in the art without departing from the spirit and scope of the present disclosure. Therefore, the scope of protection of the present disclosure shall be defined by the appended claims.

What is claimed is:

1. A power converter, comprising:
a transformer, comprising:
a primary side winding disposed on a primary side of the transformer;
a magnetic inductor coupled to the primary side winding in parallel; and
a secondary side winding disposed on a secondary side of the transformer and coupled to the primary side winding;
a resonant circuit coupled to the primary side winding;
a switch circuit, comprising:
a first switch; and
a second switch coupled to the first switch in series, wherein the resonant circuit is coupled between the first switch and the second switch; and
an auxiliary circuit disposed on the primary side, comprising:
an auxiliary winding;
an auxiliary switch coupled to the auxiliary winding; and
an auxiliary capacitor coupled to the auxiliary switch in series, wherein the auxiliary switch is switched off and the magnetic inductor discharges to charge the auxiliary capacitor;
wherein the auxiliary switch is switched on to make the auxiliary capacitor charge the magnetic inductor to generate an exciting current, and the exciting current switches on a parasitic diode of the first switch.

2. The power converter of claim 1, wherein the first switch comprises a first parasitic capacitor, and a capacitance value of the first parasitic capacitor is less than an energy storage capacitance value of the auxiliary capacitor.

3. The power converter of claim 2, wherein the second switch comprises a second parasitic capacitor, and a capacitance value of the second parasitic capacitor is less than the energy storage capacitance value.

4. The power converter of claim 3, wherein an input voltage charges the magnetic inductor when the first switch is switched on and the second switch is switched off.

5. The power converter of claim 4, wherein energy of the primary side winding is transferred to the secondary side winding when the first switch is switched off and the second switch is switched on.

6. The power converter of claim 4, wherein the magnetic inductor, the first parasitic capacitor, and the second parasitic capacitor generate a resonance with a resonant cycle when the first switch is switched off and the second switch is switched off, and the magnetic inductor discharges energy to zero.

7. The power converter of claim 6, wherein the resonant cycle is positively correlated with an output voltage value on the secondary side.

8. The power converter of claim 3, wherein an exciting current value of the exciting current is based on a following equation:
$${I}_{MAGneg} = \sqrt{\frac{( {Coss}_{S 1} + C o s {s}_{S 2} ) \cdot {V}_{PFC}^{2}}{{L}_{m}}}$$
wherein I_{MAGneg} is the exciting current value, V_{PFC} is an input voltage value, Cossₛ₁ is the capacitance value of the first parasitic capacitor, Cossₛ₂ is the capacitance value of the second parasitic capacitor, and Lₘ is a magnetic inductor value of the magnetic inductor.

9. The power converter of claim 2, wherein the auxiliary switch comprises an auxiliary parasitic capacitor, and a capacitance value of the auxiliary parasitic capacitor is less than the capacitance value of the first parasitic capacitor.

10. The power converter of claim 9, wherein a drive loss P_{gate} of the auxiliary parasitic capacitor is based on a following equation:
$${P}_{gate} = 0.5 \cdot Ciss \cdot {V}_{gate}^{2} \cdot {f}_{sw}$$
wherein Ciss is the capacitance value of the auxiliary parasitic capacitor, V_{gate} is a gate voltage of the auxiliary switch, and f_{sw} is an operating frequency.

11. The power converter of claim 1, wherein a voltage stress of the auxiliary switch and a turns ratio of the primary side winding and the secondary side winding are related by a ratio.

12. The power converter of claim 1, wherein a first terminal of the auxiliary capacitor is coupled to a first terminal of the auxiliary winding, a second terminal of the auxiliary capacitor is coupled to a first terminal of the auxiliary switch, and a second terminal of the auxiliary switch is coupled to a second terminal of the auxiliary winding.

13. The power converter of claim 1, wherein the auxiliary switch is a transistor of a first size and the first switch is a transistor of a second size, wherein the first size is less than the second size.

14. The power converter of claim 13, wherein the second switch is a transistor of a third size, and the third size is greater than the first size.

15. A method of controlling a power converter, wherein the power converter comprises a switch circuit having a first switch and a second switch, a transformer having a primary side winding, a magnetic inductor, and a secondary side winding, a resonant circuit coupled between the primary side winding and the switch circuit, and an auxiliary circuit having an auxiliary winding, an auxiliary switch, and an auxiliary capacitor, wherein the auxiliary circuit and the primary side winding are disposed on a same side of the transformer, wherein the method comprises:
switching on the second switch and charging the auxiliary capacitor up to a first interval by discharging the magnetic inductor;
switching off the second switch and switching on the auxiliary switch to make the auxiliary capacitor charge the magnetic inductor to generate an exciting current during a second interval after the first interval; and
switching off the auxiliary switch and switching on a parasitic diode of the first switch by the exciting current flowing through the first switch during a third interval after the second interval.

16. The method of claim 15, further comprising:
switching off the first switch and discharging energy of the magnetic inductor by the second switch during a discharging energy interval, wherein the discharging energy interval is between the first interval and the second interval; and
generating resonance having a resonant period by the magnetic inductor, a first parasitic capacitor of the first switch, and a second parasitic capacitor of the second switch during a resonant interval, wherein the resonant interval is after the discharging energy interval and before the second interval.

17. The method of claim 16, wherein a current flowing through the magnetic inductor is zero at the end of the resonant interval.

18. The method of claim 15, wherein the second interval is shorter than the first interval.

19. The method of claim 15, wherein a turns ratio of the primary side winding over the auxiliary winding is greater than 1.

20. The method of claim 15, further comprising:
switching off the first switch and switching on the second switch to make energy of the primary side winding transferred to the secondary side winding during the first interval.

21. A controller configured to control a power converter, wherein the power converter comprises a switch circuit having a first switch and a second switch, a transformer having a primary side winding, a magnetic inductor, and a secondary side winding, a resonant circuit coupled between the primary side winding and the switch circuit, and an auxiliary circuit having an auxiliary winding, an auxiliary switch, and an auxiliary capacitor, wherein the auxiliary circuit and the primary side winding are disposed on a same side of the transformer,
wherein the controller is configured to:
switch on the second switch and charge the auxiliary capacitor up to a first interval by discharging the magnetic inductor;
switch off the second switch and switch on the auxiliary switch to make the auxiliary capacitor charge the magnetic inductor to generate an exciting current during a second interval after the first interval; and
switch off the auxiliary switch and switch on the first switch after switching on a parasitic diode of the first switch by the exciting current flowing through the first switch during a third interval after the second interval.
